(19) United States
(12) Patent Application Publication
(10) Pub. No.: US 2019/0373817 A1
(43) Pub. Date: Dec. 12, 2019

(54) SEGMENTED ADDRESSABLE LIGHT ENGINE FOR HORTICULTURE

(71) Applicant: SIGNIFY HOLDING B.V., EINDHOVEN (NL)

(72) Inventors: MARC ANDRE DE SAMBER, LOMMEL (BE); NORBERTUS ANTONIUS MARIA SWEEGERS, LIEROP (NL)

(21) Appl. No.: 16/463,147

(22) PCT Filed: Nov. 20, 2017
(86) PCT No.: PCT/EP2017/079744

§ 371 Date: May 22, 2019

(30) Foreign Application Priority Data
Nov. 22, 2016 (EP) 16199928.9

(51) Int. Cl. A01G 7/04; A01G 9/12; F21S 4/20; H05B 33/08

(52) U.S. Cl. CPC A01G 7/045; A01G 9/12; A01G 25/00; H05B 33/0842; F21S 4/20

(57) ABSTRACT

The invention provides a horticulture arrangement (2) configured for support of a plant part (6) of a plant (5), comprising a horticulture lighting system (1) for horticulture lighting, the horticulture lighting system (1) comprising a light generating device (10) and an element (100), the element (100) having an elongated shape with an element length (L1), the element (100) comprising a plurality of light emitting regions (200) adapted to provide horticulture light (201) during operation of the light generating device (10), wherein an arrangement of positions of the light emitting regions (200) along the length (L1) of the element (100) is controllable.

### FIELD OF THE INVENTION

The invention relates to a horticulture lighting system comprising a light source as well as a horticulture arrangement comprising such horticulture lighting system. The invention further relates to a method of treating a plant, wherein such horticulture lighting system or horticulture arrangement is applied.

### BACKGROUND OF THE INVENTION

Devices for enhancing growth of a plant are known in the art. WO2010/109395, for instance, describes a device for enhancing growth of at least one plant, the device comprising at least one light source, a number of light guides and at least one light emitting part on each light guide, wherein the light guide is provided for guiding light from the light source to the light emitting part, characterized in that the device comprises a support to be positioned above the plant, and the light guides are suspended from the support. The support is at least vertically adjustable with respect to a surface in which the plant is grown.

WO 2014/037860 A1 discloses a method for enhancing the nutritional value in a first plant part of a crop, wherein the first plant part comprises an edible plant part and wherein the crop in addition to the first plant part comprises one or more other plant parts. The method comprises illuminating during a nutritional enhancement lighting period said first plant part with horticulture light that is selected to enhance formation of a nutrient in said first plant part while allowing one or more other plant parts to be subjected to different light conditions, wherein the nutritional enhancement lighting period is started within two weeks from harvest of the first plant part.

### SUMMARY OF THE INVENTION

Plants use the process of photosynthesis to convert light, CO₂ and H₂O into carbohydrates (sugars). These sugars are used to fuel metabolic processes. The excess of sugars is used for biomass formation. This biomass formation includes stem elongation, increase of leaf area, flowering, fruit formation, etc. The photoreceptor responsible for photosynthesis is chlorophyll. Apart from photosynthesis, also photoperiodism, phototropism and photomorphogenesis are representative processes related to interaction between radiation and plants:

photoperiodism refers to the ability that plants have to sense and measure the periodicity of radiation (e.g. to induce flowering),

phototropism refers to the growth movement of the plant towards and away from the radiation, and

photomorphogenesis refers to the change in form in response to the quality and quantity of radiation.

Two important absorption peaks of chlorophyll a and b are located in the red and blue regions, especially from 625-675 nm and from 425-475 nm, respectively. Additionally, there are also other localized peaks at near-UV (300-400 nm) and in the far-red region (700-800 nm). The main photosynthetic activity seems to take place within the wavelength range 400-700 nm. Radiation within this range is called photosynthetically active radiation (PAR).

Other photo sensitive processes in plants include phytochromes. Phytochrome activity steers different responses such as leaf expansion, neighbor perception, shade avoidance, stem elongation, seed germination and flowering induction. The phytochrome photo system includes two forms of phytochromes, Pr and Pfr, which have their sensitivity peaks in the red at 660 nm and in the far-red at 730 nm, respectively.

In horticulture, the photosynthetic photon flux density (PPFD) is measured in number of photons per second per unit of area (in μmol/sec/m²; a mol corresponding to 6·10²³ photons). In practice, when applying e.g. inter-lighting (see below), especially for tomatoes, the red PPFD used may be typically 200 μmol/sec/m² and the ratio blue:red may be typically 1:7 (with red and blue ranging from 625-675 nm and from 400-475 nm respectively). Especially, the photosynthetic photon flux density may comprise about 10% blue and about 90% red. The PPFD can be determined from a photodiode or measured directly with a photomultiplier. The area in the PPFD refers to the local light receiving (plant) area of the space wherein the light source(s) are arranged. In case of a multi-layer system, it is the area of a relevant layer comprised in the multi-layer configuration; the PPFD may then be estimated in relation to each layer individually (see further also below). The area may be a value in an embodiment fed to the control unit manually, or may in an embodiment be evaluated (with e.g. sensors) by the control unit.

Plant growth depends not only on the amount of light but also on spectral composition, duration, and timing of the light on the plant. A combination of parameter values in terms of these aspects is called “light recipe” for growing the plant (herein, the words plant and crop can be interchanged).

LEDs can play a variety of roles in horticultural lighting such as:
1. Supplemental lighting: Lighting that supplements the natural daylight is used in order to increase production (of tomatoes for example) or extend crop production during e.g. the autumn, winter, and spring period when crop prices may be higher.
2. Photoperiodic lighting: The daily duration of light is important for many plants. The ratio of the light and dark period in a 24 hour cycle influences the blossoming response of many plants. Manipulating this ratio by means of supplemental lighting enables regulating the time of blossoming.
3. Cultivation without daylight in plant factories.
4. Tissue culture.

For providing supplemental lighting during autumn, winter and spring in green-houses (or all-year round in multi-layer growth), in general high-power gas-discharge lamps are used that have to be mounted at a relative high location above the plants to ensure sufficiently uniform light distribution across the plants. At present, in green houses different types of high power lamps ranging from 600 up to 1000 W (e.g. high power HID) are used to provide plants with supplemental light. One drawback is that from the location above the plants the amount of light reaching the lower parts of the plant may be rather limited, dependent upon the type of crop. At the same time, the lower parts of the plant are often most in need of supplemental light. The same dilemma persists when using solid state lighting that is mounted above the plants. Nevertheless, LED lighting, especially solid state lighting, has some advantages over discharge based lighting.

In circumstances that plants get insufficient light from natural sunlight, e.g. in northern regions or in so-called “city farming” or “vertical farming” that fully rely on artificial and well controlled conditions, there appears to be a need to provide light to the plant for growing (leaf and fruit), ripening and pre-harvest conditioning.

Light is not the only enabler for growth; also atmosphere (humidity level, CO₂/O₂ levels, etc.), water, nutrients and spore elements are of main importance. Temperature (and temperature profile/cycles over day/night) is also a key contributor to the success of growing plants. In the field of open air horticulture, it seems that there is a need for soilless or hydroponic horticulture, typically used for now in high profit/high value cultivation. Such methods are also based on non-natural growing of plants and could require or profit from artificial optimizations.

Presently existing system may not be sufficiently able to provide the desired light and/or other conditions at specific parts of the plant and/or nearby of the plant. For instance, the desired lighting conditions may vary per part of the plant and may also vary in time. Presently existing systems may not be able to address one or more of such desired properties.

Hence, it is an aspect to provide an alternative (horticulture) system or arrangement which preferably further at least partly obviate(s) one or more of above-described drawbacks and/or which may be able to address one or more of such desired properties.

In a first aspect, a horticulture arrangement (herein also indicated as “arrangement”) is provided, comprising a horticulture lighting system (herein also indicated as “system”) for horticulture lighting, the horticulture lighting system comprising a light generating device and an element, the element especially having an elongated shape with an element length, the element comprising one or more light emitting regions, especially the element comprising a plurality of light emitting regions, adapted to provide horticulture light during operation of the light generating device (to a plurality of (different) parts of the plant), wherein especially one or more of (i) an arrangement of positions of the light emitting regions along the length of the element, (ii) intensities of the horticulture light of the plurality of light emitting regions, and (iii) a spectral distribution of the horticulture light of the plurality of light emitting regions is controllable. Especially, the element can be configured for support of a plant part, such as especially selected from the group consisting of a plant stem, a plant branch, a fruit, and a flower, of a plant. Hence, (in this way) the horticulture arrangement is in specific embodiments configured for support of a plant part of a plant. Therefore, the horticulture arrangement in operation is especially configured for support of a plant part of a plant (with the element). In the context of this disclosure, the term ‘support’ of a plant or plant part refers to a mechanical or physical support for the plant or plant part.

In yet a further aspect, such system per se is provided. Such horticulture lighting system for horticulture lighting may comprise a light generating device and an element, the element having an elongated shape with an element length, the element comprising a plurality of light emitting regions adapted to provide horticulture light during operation of the light generating device (to a plurality of different parts of the plant), wherein one or more of (i) intensities of the horticulture light of the plurality of light emitting regions, (ii) a spectral distribution of the horticulture light of the plurality of light emitting regions, and (iii) an arrangement of positions of the light emitting regions along the length of the element, are controllable. In specific embodiments, also further elucidate below, especially the element may be one of (i) bendable in a plurality of fixed configurations, and (ii) rigid. Especially, the element may be configurable for support of a plant part, such as especially selected from the group consisting of a plant stem, a plant branch, a fruit, and a flower, of a plant.

With such system and/or arrangement it may be possible to address different parts of the plant with light desired for the specific part(s) and/or the specific growth stadium of the plant and/or the specific time of the year, etc. For instance, in dependence of the plant, the type of plant part and/or the specific time of the year the light intensity and/or spectral distribution may be selected. Further, such system and/or arrangement may also relatively easily allow implementation of other functionalities, such as providing locally water and/or a gas, or locally heating, etc.

Hence, especially one or more of (i) arrangement of positions of the light emitting regions along the length of the element, (ii) intensities of the horticulture light of the plurality of light emitting regions, and (iii) a spectral distribution of the horticulture light of the plurality of light emitting regions is controllable, and additionally or alternatively (iv) one or more (local) environmental conditions is controllable, such as temperature, relative humidity, gas flow, gas compositions, etc.

With such system and/or arrangement it may also be possible to dynamically control the system and/or arrangement, e.g. day-by-day adapted, including (re)acting on the growing plant, such as adapting e.g. the lighting conditions and/or other conditions to the physical size of the plant, etc.

As indicated above, the horticulture arrangement may thus comprise a horticulture lighting system for horticulture lighting (as well as a plant that may receive the horticulture light during use of the system).

The horticulture lighting system comprises a light generating device which is especially used to provide (optionally after some modification of the spectral distribution of the light of the light generating device) the horticulture light. The term “horticulture light” especially refers to the light that is provided by the system (during use of the system) and which ca be provided to one or more parts of the plant. The term “light” especially refers to visible light, but may in embodiments also refer to one or more of UV radiation and infrared radiation. The light generation device is especially a solid state lighting device. Further, the term “light generation device” may also refer to a plurality of (different) light generation devices. The light generating device(s) may optionally be color tunable.

The term “horticulture” relates to (intensive) plant cultivation for human use and is very diverse in its activities, incorporating plants for food (fruits, vegetables, mushrooms, culinary herbs) and non-food crops (flowers, trees and shrubs, turf-grass, hops, grapes, medicinal herbs). Horticulture is the branch of agriculture that deals with the art, science, technology, and business of growing plants. It may include the cultivation of medicinal plants, fruits, vegetables, nuts, seeds, herbs, sprouts, mushrooms, algae, flowers, seaweeds and non-food crops such as grass and ornamental trees and plants. Here, the term “plant” is used to refer essentially any species selected from medicinal plants, vegetables, herbs, sprouts, mushrooms, plants bearing nuts, plants bearing seeds, plants bearing flowers, plants bearing fruits, non-food crops such as grass and ornamental trees, etc.

The term “crop” is used herein to indicate the horticulture plant that is grown or was grown. Plants of the same kind grown on a large scale for food, clothing, etc., may be called crops. A crop is a non-animal species or variety that is grown to be harvested as e.g. food, livestock fodder, fuel, or for any other economic purpose. The term “crop” may also relate to a plurality of crops. Horticulture crops may especially refer to food crops (tomatoes, peppers, cucumbers and lettuce), as well as to plants (potentially) bearing such crops, such as a tomato plant, a pepper plant, a cucumber plant, etc. Horticulture may herein in general relate to e.g. crop and non-crop plants. Examples of crop plants are Rice, Wheat, Barley, Oats, Chickpea, Pea, Cowpea, Lentil, Green gram, Black gram, Soybean, Common bean, Moth bean, Linseed, Sesame, Khesari, Sunhemp, Chillies, Brinjal, Tomato, Cucumber, Okra, Peanut, Potato, Corn, Pearlmillet, Rye, Alfalfa, Radish, Cabbage, Lettuce, Pepper, Sunflower, Sugarbeet, Castor, Red clover, White clover, Safflower, Spinach, Onion, Garlic, Turnip, Squash, Muskmelon, Watermelon, Cucumber, Pumpkin, Kenaf, Oilpalm, Carrot, Coconut, Papaya, Sugarcane, Coffee, Cocoa, Tea, Apple, Pears, Peaches, Cherries, Grapes, Almond, Strawberries, Pine apple, Banana, Cashew, Irish, Cassava, Taro, Rubber, Sorghum, Cotton, Triticale, Pigeonpea, and Tobacco. Especial of interest are tomato, cucumber, pepper, lettuce, water melon, papaya, apple, pear, peach, cherry, grape, and strawberry.

Further, the horticulture lighting system comprises an element. The element is especially an element that is configured (or can be configured) for support of a plant part, such as especially selected from the group consisting of a plant stem, a plant branch, a fruit, and a flower, of a plant. Hence, the element may especially have an elongated shape with an element length. Hence, the plant is especially a plant having a stem and optionally one or more of a plant branch, a fruit and a flower.

The term “element” may in embodiments also refer to a plurality of (different) elements that may be functionally coupled. For instance, a plurality of elements may be coupled to provide a longer element. This may e.g. be useful for longer plants. Alternatively, or additionally, a plurality of elements may be coupled to provide a branched element. This may for instance be useful for plants that generate relatively longer branches and/or branches with relatively heavy fruits, etc. The term “functionally coupling” and similar terms may refer to physically coupling, such that e.g. an integrated system of physically coupled elements is provided. Coupling may be done with e.g. a click system, screwing together, gluing together, or using connection elements, etc. etc., as known to a person skilled in the art. The term “functionally coupling” and similar terms may (further) refer to providing an electrical connection between two (or more) elements. In this way, e.g. remote electronic elements may be controlled (like a light source or a sensor, etc.). The term “functionally coupling” and similar terms may (further) refer to providing an optical connection between two (or more) elements. This may especially be relevant when the elements include waveguides. In this way light from one element may be coupled in a functionally coupled next element. The term “functionally coupling” and similar terms may (further) refer to providing a fluid connection between two (or more) elements. This may especially be relevant when the elements include channels for transport of a gas or a liquid.

As indicated above, the element comprises one or more light emitting regions (“segments”), especially the element comprises a plurality of light emitting regions, such as at least two, like at least four. For instance, the element may comprise at least one light emitting region per meter element. The length of the element may be in the range of at least 10 cm, such as at least 20 cm, like at least 50 cm, such as even up to 500 cm.

Especially, two main types of embodiments are herein suggested. In first embodiments, the element comprises a waveguide, and the light generating device may be configured relatively remote from the light emitting region, as light may propagate through the waveguide from the light generating device to the (remote) light emitting region. In second embodiments, the light generating device may be relatively close to the light emitting region or may essentially be comprised thereby. More especially, in the latter embodiment, the horticulture lighting system may especially include a plurality of light generating devices.

Hence, in the first embodiments a distance between a light emitting surface of the light generating device (such as a LED die) and at least one or more light emitting regions may be at least 20 mm, such as at least 5 cm, whereas in the second embodiments a distance between a light emitting surface of the light generating device and at least one or more light emitting regions may be less than 20 mm, such as less than 10 mm, such as even less than about 1 mm.

The horticulture lighting system is especially adapted to provide horticulture light during operation of the light generating device. Hence, during use the light generating device provides light, that (i) may e.g. be directly emitted from the light emitting region, that (ii) may be directly emitted from the light emitting region but including at least a partial conversion (such as with a luminescent material) of the light of the light source, or that (iii) may first travel through at least part of a waveguide comprised by the element and may then be emitted from the light emitting region (including optionally at least a partial conversion of the light of the light source). In this way, the horticulture lighting system and arrangement may be used to provide horticulture light to one or more different parts of the plant, especially a plurality of different parts of the plant.

The phrase “different parts of the plant” may refer to different parts of the same type, such as different parts of a plant stem. In specific embodiments, this may (additionally) also refer to different types of parts of the plant, such to a part of the stem and a part of a fruit.

Whether or not light may be provided may in embodiments be controlled. Further, in embodiments also the positions where the horticulture light is provided may be controlled. Hence, in specific embodiments one or more of (i) arrangement of positions of the light emitting regions along the length of the element, (ii) intensities of the horticulture light of the plurality of light emitting regions, and (iii) a spectral distribution of the horticulture light of the plurality of light emitting regions is controllable.

Especially, in embodiments at least the arrangement of positions of the light emitting regions along the length of the element is controllable. Alternatively or additionally, in embodiments at least the spectral distribution of the horticulture light of the plurality of light emitting regions is controllable.

Here, controlling may be done e.g. manually or with a control system. The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior.

As indicated above, in embodiments the element comprises a waveguide, wherein the light generating device is configured to couple device light into said waveguide. Such light generating device may include a light emitting surface, such as a LED die, that may be embedded in the waveguide or that may be configured at some distance of the waveguide.

The light generating device is especially optically coupled with the waveguide. Hence, the light generating device and the waveguide are radiationally coupled. The term “radiationally coupled” especially means that the light generating device and the waveguide are associated with each other so that at least part of the radiation emitted by the light generating device is received by the waveguide and can propagate through the waveguide. The waveguide may e.g. comprise a fiber. The waveguide may have a circular cross-section or a square cross-section or any other suitable cross-section. Instead of the term “radiationally coupled” also the term “optically coupled” may be used.

In yet further specific embodiments the horticulture lighting system or horticulture arrangement further comprises lighting elements which may especially movable be associated with the element for positioning the lighting elements at the element, wherein the lighting elements are optically coupled (via the waveguide) with the light generating device and are configured to provide said horticulture light during operation of the light generating device. Instead of the term “optically coupled” and similar terms also the term “radiationally coupled” may be used (see also above). Here, the term “radiationally coupled” especially means that the light generating device and the lighting elements are associated with each other so that at least part of the radiation emitted by the light generating device is received by the lighting elements and coupled out, optionally after conversion into converted light, especially luminescence.

Alternatively or additionally, the lighting elements may also have a filter function. For instance, part of the light of the light generating means may (at least partly) be blocked. Hence, the lighting elements may also be used to adapt the spectral distribution of the light of the light generating device to provide horticulture light based on part of the light of the light generating device.

Hence, in embodiments the lighting elements may include outcoupling structures configured to couple at least part of the light in the waveguide out. In this way, at a position where the lighting element is configured, light may escape from the waveguide and be used as horticulture light. Alternatively or additionally, the waveguide may comprise a light transmissive material at an outer side having an index of refraction smaller than the waveguide material at an inner side, which may facilitate outcoupling of the light from the waveguide. Hence, the lighting elements may especially comprise a light transmissive material.

The light transmissive material may comprise one or more materials selected from the group consisting of a transmissive organic material, such as selected from the group consisting of PE (polyethylene), PP (polypropylene), PEN (polyethylene napthalate), PC (polycarbonate), polymethylacrylate (PMA), polymethylmethacrylate (PMMA) (Plexiglas or Perspex), cellulose acetate butyrate (CAB), silicone, polyvinylchloride (PVC), polyethylene terephthalate (PET), including in an embodiment (PETG) (glycol modified polyethylene terephthalate), PDMS (polydimethylsiloxane), and COC (cyclo olefin copolymer). Especially, the light transmissive material may comprise an aromatic polyester, or a copolymer thereof, such as e.g. polycarbonate (PC), poly (methyl)methacrylate (P(M)MA), polyglycolide or polyglycolic acid (PGA), polylactic acid (PLA), polycaprolactone (PCL), polyethylene adipate (PEA), polyhydroxy alkanoate (PHA), polyhydroxy butyrate (PHB), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN). Hence, the light transmissive material is especially a polymeric light transmissive material. However, in another embodiment the light transmissive material may comprise an inorganic material. Especially, the inorganic light transmissive material may be selected from the group consisting of glasses, (fused) quartz, transmissive ceramic materials, and silicones. Also hybrid materials, comprising both inorganic and organic parts may be applied. Especially, the light transmissive material comprises one or more of PMMA, transparent PC, or glass.

Hence, in embodiments one or more lighting elements are configured to couple said device light out of the waveguide via said one or more lighting elements. Therefore, the lighting elements may especially be configured to facilitate outcoupling of light from the waveguide via the lighting elements. Hence, the light generating device couples light into the waveguide, and the lighting elements may couple the device light out of the waveguide via said one or more lighting elements.

In embodiments, the lighting element(s) may further include a luminescent material configured to receive part of the light of the light generating device via the waveguide and convert at least part of the received light into luminescent material light. At least part of this luminescent material light, optionally in combination with remaining light of the light generating device, may be used as horticulture light. Therefore, in embodiments one or more lighting elements are configured to receive said device light from (i.e. via) the waveguide, convert at least part of said device light with a wavelength converter into converted light, to provide thereby said horticulture light comprising at least part of said converted light.

In specific embodiments, the lighting elements are configured as sleeves slidably associated with the element. For instance, when the element comprises a fiber waveguide (having an essentially circular cross-section), the lighting element(s) may circumferentially surround at least part of the fiber, whereby the lighting element may only have a degree of freedom along the element. Hence, in yet a further aspect the invention also provides such sleeve per se. The sleeve is especially configured to be slidably attached to the element of a system as described herein. The sleeve may have a shape that it can circumferentially surround at least part of the element. The sleeve may comprise one or more of outcoupling structures, a luminescent material, and a material having an index of refraction lower than the element for which it is intended to be used. Further, the sleeve may comprise a light transmissive material, especially a polymeric light transmissive material (see also above for examples thereof).

The lighting elements that are moveable associated with the element may have a length in the range of 0.2-50 cm, such as 0.5-20 cm, though other dimensions may also be possible. The total length of the lighting elements may be in the range of 1-80%, such as 2-50%, of the length of the element.

Therefore, to provide a (non-permanent, as the lighting elements may be movable) local outcoupling the total internal reflection (TIR) of the waveguide may be modified. One or more options may be selected from the group consisting of (1) changing the curvature of the wave guide, (2) applying a micro-structures contact (to the waveguide) with the sleeve, (3) applying a diffusively reflective coating (with the sleeve), (4) applying a deformation on the waveguide (for the case that the waveguide is soft and temporarily deformable). Such deformation may e.g. be possible when the waveguide is relatively soft. In such embodiments, e.g. the sleeve may be configured to press on at least part of the waveguide and deform it (as long as the sleeve is attached to the waveguide). When the sleeve is moved along the waveguide, the deformation may be essentially terminated (relaxed) at a position where the sleeve was and a deformation may be created at a position where the sleeve is (again) configured.

The lighting system or arrangement may include at least one lighting element, even more especially at least two lighting elements, like at least four lighting elements. In general, the lighting system or arrangement may include at least one lighting element per meter of element (see also above).

When the lighting elements essentially only couple light out of the waveguide, without conversion, the spectral properties of the horticulture light provided by the lighting elements may essentially be the same. However, in other embodiments one or more of the distribution of the light (such as spatial light flux or beam shape) and the intensity of the light may differ between two or more lighting elements. This may e.g. be achieved with a different number of outcoupling structures and/or a different shape of the outcoupling structures.

When the lighting elements also convert light, also the spectral properties of the horticulture light provided by the lighting elements may essentially be the same. However, in other embodiments one or more of the distribution of the light (such as spatial light flux or beam shape), the intensity of the light, and the spectral distribution of the light may differ between two or more lighting elements. This may e.g. be achieved with a different number of outcoupling structures and/or a different shape of the outcoupling structures and/or different types of luminescent materials. In this way, different lighting elements may be used to provide different lighting conditions at different position along the element. In this way, different parts of a plant may be provided with different lighting conditions (if desired). The lighting elements are comprised by the light emitting regions or may define the light emitting regions.

Hence, in yet a further aspect also a kit of parts is provided, the kit of parts comprising the element and a plurality of lighting elements that can be movable associated with the element. When light of two or more lighting elements have different spectral distributions, this may especially imply that a spectral overlap of (normalized) horticulture light spectral distributions of the different elements is less than 95%.

As indicated above, a plurality of elements may be functionally coupled to provide a branched element and/or a plurality of elements may be coupled to provide a longer element. Therefore, in specific embodiments the lighting system or horticulture arrangement may comprise a plurality of waveguides with two or more waveguides configured optically coupled which each other, wherein the light generating device is configured to couple device light into a first waveguide, and wherein a second waveguide is configured to receive at least part of said device light via the first waveguide. Hence, the waveguides are especially optically coupled, whether they are configured in series one after the other or configured in one or more branched configurations. Examples of branched configurations are e.g. a T-configuration or a Y-configuration. Branching may be used to provide a more extended network, e.g. for supporting plant branches. However, branching may also be used to increase intensity of the horticulture light. For instance, a plurality of light generation device may be used, each coupled to a branch, wherein two or more branches merge into a single waveguide receiving light of two or more light generating devices.

The element comprising the waveguide may be flexible and may e.g. be wrapped or folded around a plant stem or plant branch (if any). Alternatively or additionally, the plant stem or plant branch (if any) may be wrapped around the element comprising the waveguide (see further also below).

In yet further embodiments, the element comprises an elongated unit comprising a plurality of light generating devices configured to provide device light, wherein the plurality of light generating devices are configured at different positons along the length of the element.

Hence, though some of the former described embodiments could use a single light generating device, in these embodiments especially a plurality of light generating devices is applied. Therefore, where the former embodiments can use the transport of light to provide different light emitting regions, in these embodiments, wherein an elongated unit is applied, the generation and/or transport of electricity at different positions of the element may be necessary. For instance, the elongated unit may include a LED strip, with a plurality of LEDs (and electrical wiring for providing electricity to the respective LEDs). The light generating devices provide light. In this way, each light generating region may provide light.

Hence, in such embodiments in fact the light emitting regions may comprise said light generating devices. Especially, in such embodiments (but also in other embodiments) the horticulture lighting system or horticulture arrangement may further comprise a control system configured to control one or more of (i) intensities of the horticulture light of the plurality of light emitting regions, and (ii) the spectral distribution of the horticulture light of the plurality of light emitting regions. Especially, the spectral distributions of horticulture light of different light emitting regions are individually controllable, which allows providing specific types of light at specific positions.

The control system may be configured to control a plurality of elongated units would the system or arrangement comprise a plurality of elongated units.

The light provided by the light generating devices may be the horticulture light, though there may in embodiments be some adaption of the light of the light generation devices due to the use of an optical filter and/or a luminescent material. Hence, the horticulture light may especially comprise the light of the light generating device(s) and/or converted light of the light generating device(s) and/or optically filtered light of the light generating devices.

Herein, the term elongated unit is applied as the elongated unit may e.g. comprise a LED strip but the element may also comprise an LED strip and a support for the LED strip. Herein, the support for the LED strip, or other elongated unit, or element, is also indicated as reinforcing element (see also below). The LED strip is especially flexible, whereas the support may in embodiments e.g. be bendable in a plurality of configurations. Hence, the element may in embodiments essentially consist of the elongated unit and may in other embodiments comprise the elongated unit and other elements (see further also below). Hence, in embodiments the length of the elongated unit may be (essentially) the same as the length of the element.

The arrangement, more especially the elongated unit, may include at least one light emitting region, even more especially at least two light emitting regions, like at least four lighting light emitting region, with each light emitting region comprising a light generating device. In general, the arrangement may include at least one light emitting region per meter element (see also above).

The light emitting region(s) comprising light generating device(s) may have a length in the range of 0.2-50 cm, such as 0.5-20 cm, though other dimensions may also be possible. The total length of the light emitting region may be in the range of 1-80%, such as 2-50%, of the length of the element. The light emitting region is a part of the element (or elongated unit) from which horticulture light escapes.

As the elongated unit comprises a plurality of light generating devices this may also allow a controlling of the light of the light generating devices. All light generating devices may be the same and the horticulture light provided by the light emitting regions may essentially be the same. In such embodiments, essentially only the intensity of the horticulture light may be controlled. However, one or more light generating devices may also be radiationally coupled with optical elements that may influence the light, such as in term of beam shape, flux, intensity, spectral distribution, etc. For instance, one or more light generating devices may comprise different luminescent materials and/or one or more light generating devices comprise different solid state light sources. In this way, different lighting elements may be used to provide different lighting conditions at different position along the element. In this way, different parts of a plant may be provided with different lighting conditions (if desired). Hence, in specific embodiments one or more of (i) the spectral distribution of the horticulture light of one or more light emitting regions is individually controllable, and (ii) spectral distributions of horticulture light of different light emitting regions are individually controllable. The light generating device(s) may optionally be color tunable. Further, optionally two or more light generating devices are individually controllable with respect to the spectra distribution of the light generated by the respective light generating devices. In this way, the desired light can be provided at the specific plant part at the desired time.

In specific embodiments, one or more regions comprise a wavelength converter configured to convert at least part of the device light into converted light, to provide thereby said horticulture light comprising at least part of said converted light. As indicated above, the wavelength converter may be the same for the one or more regions, or the wavelength converter may differ for two or more of these.

The wavelength converter especially comprises a luminescent material. The luminescent material can convert at least part of the light of the light generating device into converted light (luminescent material light) of which at least part is used as horticulture light, optionally together with at least part of the non-converted light.

The element may be used as support for the plant and/or the plant may be used as support for the element. Especially, the element may be used as support for the plant (including optional branches).

Hence, in specific embodiments (of the horticulture arrangement) the element has a first end and a second end, wherein the second end is configured higher than the first end for enabling growth of the plant stem or the plant branch along the element.

In further specific embodiments, the element may be flexible. This allows the use of the element as support for the plant and/or the use of the plant as support for the element. When the element is to be used as (at least) support for the plant (including optional branches), it may be desirable that the support is fixed between two points (a higher and a lower point, see also above), or the support is essentially rigid or configurable in (semi-fixed) positions. Hence, in embodiments the element is one of (i) bendable in a plurality of fixed configurations, and (ii) rigid.

Hence, in embodiments the light generating device may be separate from the element, wherein the element is especially a waveguide. In yet other embodiments the light generating device may at least partly be embedded in the element, wherein the element is especially a waveguide. In yet further embodiments, the element comprises a plurality of light generating devices. These may be embedded in the element or be attached to the element, such as embedded in an elongated unit or attached to an elongated unit. The elongated unit may especially be a LED strip. The LEDs may be embedded in the strip or may be attached to the strip. Combinations of embodiments may also be possible.

As indicated above, the element may be bendable in a plurality of fixed configurations or may be rigid. When e.g. the elongated unit is flexible, a plurality of fixed configurations or a rigid element may be provided when an external support element (e.g. a frame) is applied and/or when a reinforcing element is applied which may be bendable in a plurality of fixed configurations, or is rigid. Hence, in embodiments the element may be configured as support of a plant with the aid of an external support element (which may especially be rigid). Further, in embodiments the element may be configured as support of a plant with a reinforcing element (comprised by the element, such as in embodiments comprised by the elongated unit), wherein the reinforcing element is bendable in a plurality of fixed configurations or rigid. Hence, in embodiments the elongated unit may comprise a LED strip with a plurality of LEDs, wherein the LED strip is (i) bendable in a plurality of fixed configurations or (ii) rigid, and/or wherein the elongated unit further comprises a reinforcing element, wherein the reinforcing element is especially bendable in a plurality of fixed configurations or rigid. Hence, especially the reinforcing element is configured to support the LED strip. More in general, the reinforcing element may be configured to support the elongated unit.

The length of the element and the fact that the element can be used in close proximity of the plant also allows a combination with other functionalities. Hence, in embodiments (of the horticulture arrangement or the horticulture lighting system) the system or the arrangement may further comprise one or more functional devices, especially comprised by the element, wherein the one or more functional devices are configured for executing one or more of (i) measuring a temperature, (ii) measuring humidity, (iii) measuring light intensity, (iv) measuring spectral distribution of light, (v) measuring a gas, (vi) heating, (vii) providing water, (viii) providing a gas. Hence, in embodiments one or more functional devices may be configured for (locally) measuring one or more of O₂, CO₂ and ethylene, or measuring the (local) atmospheric gas composition and/or for measuring the gas exchange at the interface between the plant and the air environment. For instance, the functional devices may be attached to a waveguide or may be implemented in the elongated unit. Hence, the element can be used as support and/or for other functionalities. In embodiments, the one or more functional devices may be integrated with or attached to the element or elongated unit.

In yet a further aspect, also a method of treating a plant is provided. Especially, the method of treating the plant comprises: (i) one or more of (i) guiding a plant part, such as especially selected from the group consisting of a plant stem, a plant branch, a fruit, and a flower, of a plant along an element of the horticulture lighting system as defined herein or the horticulture arrangement as defined herein, and (ii) supporting a plant part, such as especially selected from the group consisting of a plant stem, a plant branch, a fruit, and a flower, of a plant with the element of said horticulture lighting system or horticulture arrangement; and (ii) irradiating with horticulture light at least part of the plant. The irradiation with the horticulture light may in embodiments be done in response to a sensor signal or input data (provided to a control system). The irradiation with the horticulture light may in embodiments be done in response to e.g. one or more of time of the day, season of the year, (local) lighting conditions, age of plant, condition of the plant, planting period, etc. Hence, the irradiation with the horticulture light may in embodiments be done in response to plant related data, time related parameters, conditions to which the plant is subjected (such as natural light, temperature, gas composition, feed, etc. etc.), etc.

### BRIEF DESCRIPTION OF THE DRAWINGS

Embodiments will now be described, by way of example only, with reference to the accompanying schematic drawings in which corresponding reference symbols indicate corresponding parts, and in which:

FIGS. 1a-1b schematically depict some general embodiments; and

FIGS. 2a-2e schematically depict some variants.

The schematic drawings are not necessarily on scale.

### DETAILED DESCRIPTION OF THE EMBODIMENTS

Amongst others, it is herein suggested to provide the required light (for growth, ripening, harvest preparation) at the right time and at the right location (cf. various canopies of fruits), and also the other local micro-climate conditions for the horticulture. By the use of a tunable (in color, intensity, duty cycle) and locally optimized light source, one can provide certain parts of a plant or certain plants in a group of plants with the optimal light type. An addressable light source solution will provide a way of digitally controlled tuning, without the need to mechanically re-locate the light source along the development cycle of the plant.

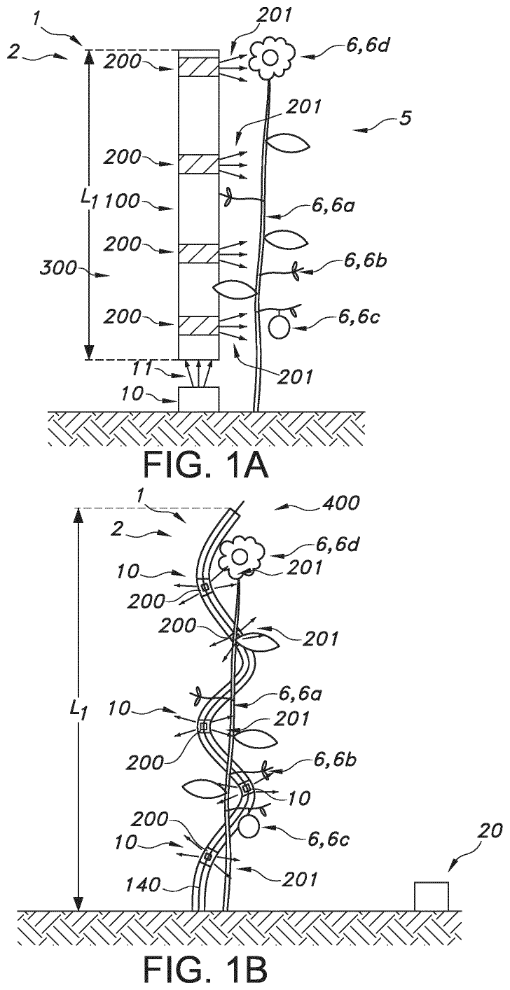

FIGS. 1a and 1b schematically depict embodiments of a horticulture arrangement 2 comprising a horticulture lighting system 1 for horticulture lighting, and, as schematically depicted, also a plant 5.

The horticulture lighting system 1 comprises a light generating device 10, e.g. a solid state light source, which is configured to generate light 11. Here, in this schematically depicted FIG. 1a, the light generating device is configured external of the element 100; in the schematically depicted FIG. 1b, a plurality of light generating devices 10 are comprised by the element 100, which is comprised by (or which is) an elongated unit 400. Hence, embodiments of a segmented light source are schematically depicted. The element 100 has an elongated shape with an element length L1. Especially, the element 100 may be configured for support of a plant part 6 or a plant 5, such as especially selected from the group consisting of a plant stem 6a, a plant branch 6b, a fruit 6c, and a flower 6c. In general, this may be indicated as supporting a plant 5, or supporting a plant part 6 of a plant 5. As can be seen, the support is for support of above soil or above aqueous liquid parts, or more in general especially for any part not (necessarily) including the roots. Hence, the system and arrangement may be used for soil-based applications, but also for hydroponics or aeroponics.

The element 100 comprises a plurality of light emitting regions 200 adapted to provide horticulture light 201 during operation of the light generating device 10.

Especially, one or more of the arrangement of positions of the light emitting regions 200 along the length L1 of the element 100, the intensities of the horticulture light 201 of the plurality of light emitting regions 200, and the spectral distribution of the horticulture light 201 of the plurality of light emitting regions 200 is controllable.

FIG. 1a especially schematically depicts an embodiment of the horticulture arrangement 2, wherein the element 100 comprises a waveguide 300. Hence, especially the light generating device 10 is configured to couple device light 11 into said waveguide 300.

FIG. 1b schematically depicts an embodiment of the horticulture arrangement 2, wherein the element 100 comprises an elongated unit 400 comprising a plurality of light generating devices 10 configured to provide device light 11. The plurality of light generating devices 10 are configured at different positons along the length L1 of the element 100, wherein the light emitting regions 200 comprise said light generating devices 10. The length L1 of the element 100 is the total length, including optional curves. The light generating devices may especially comprise solid state light sources, such as inorganic LEDs, OLEDs, lasers, VCSELs, or chip on board (COB) light sources, etc., or combinations of two or more of these.

FIG. 1b also by way of example shows a reinforcing element 140. For instance, would the elongated unit 400 be a LED strip, the reinforcing element 140 may be comprised by the strip or may be configured external from the strip. The reinforcing element 140 may provided the desired rigidness or flexibility in different configurations to the elongated unit.

The horticulture arrangement 2 or system 1 may further comprise a control system 20 configured to control one or more of the intensities of the horticulture light 201 of the plurality of light emitting regions 200, and the spectral distribution of the horticulture light 201 of the plurality of light emitting regions 200. During use, all light emitting regions 200 may provide horticulture light. However, also one or more of the light emitting regions 200 may provide horticulture light. This may be controlled with the control system.

Note that also the horticulture arrangement 2 or system 1 of the embodiment schematically depicted in FIG. 1a may include a control system 20, especially at least configured to control the intensities of the horticulture light 201 of the light emitting regions 200. The control system might also be used to drive the type of light spectrum that is coupled into the waveguide.

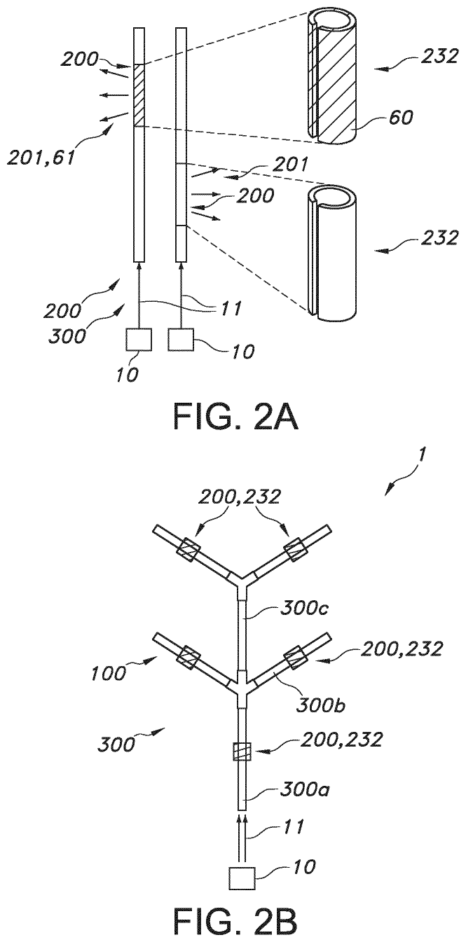

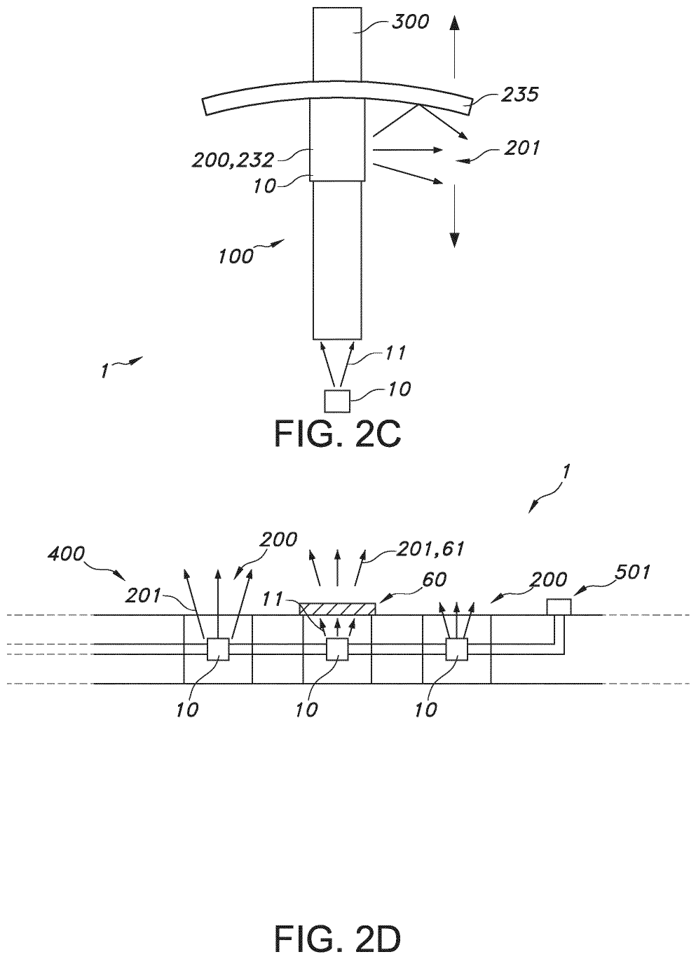

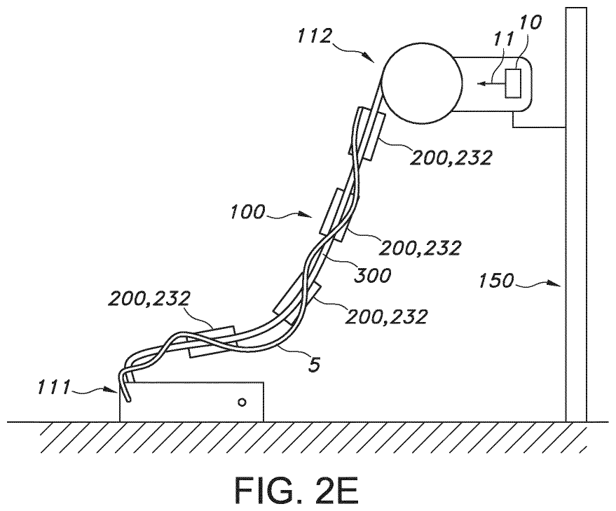

FIGS. 2a-2c schematically depict embodiments wherein the system 1 or the horticulture arrangement 2 further comprises lighting elements 232 which are movable associated with the element 100 for positioning the lighting elements 232 at the element 100.

The lighting elements 232 are optically coupled with the light generating device 10 and are configured to provide said horticulture light 201 during operation of the light generating device 10.

Hence, one or more lighting elements 232 are configured to couple said device light 11 out of the waveguide 300 via said one or more lighting elements 232. FIG. 2a shows on the right side a variant wherein the horticulture light 201 may essentially have the same spectral distribution as the light 11 of the light generating device.

FIG. 2a shows on the right side a variant wherein one or more lighting elements 232 are configured to receive said device light 11 from of the waveguide 300, convert at least part of said device light 11 with a wavelength converter 60 into converted light 61, to provide thereby said horticulture light 201 comprising at least part of said converted light 61.

Further, FIG. 2a schematically depicts embodiments wherein the lighting elements 232 are configured as sleeves slidably associated with the element 100. FIG. 2a also schematically depicts a kit of parts comprising one or more elements 100 and one or more lighting elements 232 which can be configured as sleeves slidably associated with the element(s) 100.

FIG. 2b schematically depicts an embodiment comprising a plurality of waveguides 300 with two or more waveguides 300 configured optically coupled which each other, wherein the light generating device 10 is configured to couple device light 11 into a first waveguide (e.g. 300a), and wherein a second waveguide (e.g. 300b or 300c) is configured to receive at least part of said device light 11 via the first waveguide (300a). Such configuration may be used to provide a longer element 100 (see e.g. waveguides 300a and 300c) and/or to provide a branched element 100 (see e.g. waveguides 300a and 300b).

FIG. 2c schematically depicts an embodiment wherein the system 1 further comprises an optical element 235, such as a reflector, configured to have impact on the optical properties of the horticulture light 201 generated by the light emitting region 200 (be it a sleeve type region or another type of region).

FIG. 2d schematically depicts in some more detail a part of the elongated unit 400 such as schematically depicted in FIG. 1b. By way of example, also a variant (see middle light emitting region 200) is shown wherein a region 200 comprise a wavelength converter 60 configured to convert at least part of the device light 11 into converted light 61, to provide thereby said horticulture light 201 comprising at least part of said converted light 61.

Further, FIG. 2d schematically depicts by way of example a variant further comprising one or more functional devices 510. Such functional device 510 is especially configured for executing one or more of (i) measuring a temperature, (ii) measuring humidity, (iii) measuring light intensity, (iv) measuring spectral distribution of light, (v) measuring a gas, (vi) heating, (vii) providing water, (viii) providing a gas. Here, by way of example the functional device 510 may also be an electrical device, but also other types of functional devices 510 may (additionally) be applied.

FIG. 2e schematically depicts a possible application for holding the tendril of the plant 5, e.g. of a tomato plant, with light harvesting from a light guide or wave guide 300 that transports light. Further, this Fig. also schematically depicts that the element (100) may be flexible.

Further, the element 100 has a first end 111 and a second end 112, wherein the second end 112 is configured higher than the first end 111 for enabling growth of a plant part, especially stem 6a or branch, along the element 300.

Further, FIG. 2e schematically depicts an embodiment of an external support element 150, such as a frame or a wall, etc. The external support element can be used to position the element 100.

Hence, amongst others segmented and addressable (multi-wavelength) light sources, extending along a certain length (as to address various parts of the plant or address certain plants in a group of plants with a specific type of light) are provided.

Yet further, addressability of the light segments may be provided, such as to adapt the light (type, intensity, cycles) according the growth phase of (a specific part of) the plant or a specific plant in a group of plants that are in various stages of development/growth.

Also, a light guiding element may be provided, which is combined with local out coupling sliding or click-on elements as to create local out coupling or converting light (phosphor based).

Further, in embodiments segmented heat providing elements embedded in the segmented light source may be provided. Yet further, flexibility of the segmented light source for specific use cases (e.g. in the case of tomato growing, to twist the light source around the stem of the plants) may be provided. In embodiments, local segmented heating and/or humidification and/or micro-wind flow functionality (to generate local micro-climate or e.g. facilitate pollination) can be provided. In yet further embodiments, sensing elements allowing a feedback system (e.g. for monitoring color, local actual plant or air temperature, ethylene emission, O₂ and CO₂ gas exchange at the interface of plant and atmosphere, humidity, etc., as a measure of the status of the plant and its micro-climate) etc. are provided. Further, for local external powered add-on without the need for a galvanic connection, an optical or electrical energy harvesting means, based on light energy conversion with a PV cell (or alike) or inductive or capacitive energy transfer can also be provided. In embodiments, a lighting system with segmented light spectrum emission is provided. For instance, a strip-like LED based light source is proposed that has addressable segmented zones (“regions”), each zone electrically/digitally tunable for an optimal light spectrum and intensity for a specific part of the plant or for a specific plant in a group of plants. Amongst others, the embodiments described herein can be used in greenhouse horticulture, such as for tomato cultivation. For instance, a combination of light strip and mechanical support line for use in greenhouse tomato cultivation, in accordance with today's way of tomato growing in greenhouses is herein proposed (see also FIG. 2e). Depending on the growth phase of the tomato plant (its segment) various lighting recipes are provided; e.g. tuned for optimal leaf growth, fruit growth, ripening, harvest and post-harvest optimization. Amongst others, an arrangement with UV-B-G-R-IR (alike) multi-color segments are herein proposed, such as e.g. with a typically length of 30 cm for tomato growing, that are individually addressable using a digital bus (2- or 3 wire connected). Yet further, light recipes may be provided. For instance, a setting of the lighting recipe can be:

Location based (with light setting shifting day by day to next segment along the growth phase of the tomato plant) for a range of light strips in a given greenhouse.

Fine-tuned for individual plants or group of plants, e.g. based on specific locations in the greenhouse, or based on plant type variations.

Further refined, with the use of local sensing units.

Additional overall light tuning can be provided as well, e.g. along the time of day (as would be done with any type of LED based horticulture luminaire). Especially when using an elongated unit, functional components, or at least part thereof, and/or wiring etc., may be implemented in the elongated unit, and may e.g. be sealed from the environment, such as may be the case when using a LED strip, with e.g. electrical conductors within a polymeric strip.

The embodiments described herein may e.g. be used in indoor or outdoor hydroponic horticulture. For instance, a combination with lateral growing of hydroponic crops (so called soilless horticulture) is herein suggested. This can be for both indoor and outdoor horticulture. For outdoor use a simplified light strip that provides e.g. a missing spectral element such as additional UV-A for Nordic regions, or for extending the seasonal period for growing certain plants, could be suggested. For outdoor use, an electrically safety optimized system would be advantageous. Such systems are herein described.

Herein, also versatile spectra using light conversion elements are described. For instance, a method for creating tuned light from a lighting strip is based on using segmented ‘conversion sleeves’ around the excitation wave guide, that extract/out couple the light and convert the light (starting from e.g. blue or UV-A light) to the required wavelength, see e.g. FIGS. 2a-c. The sleeves, with various light outputs depending on the embedded conversion material, could be sliding along the strip or be clip-on elements, and be positioned on the proper wanted location. This concept can be used in vertical but also in lateral/horizontal configurations for e.g. tunnel-based agriculture, in hydroponics/soilless horticulture, or in open ground horticulture. During various phases of plant growth, the conversion sleeves can be shifted to another location, or other conversion sleeves (with other light spectrum) can be applied (and the earlier sleeves decoupled for later use during a next crop).

For modular constructions, it is herein suggested to use a build-up system that allows side-branches for light splitting. This is illustrated in FIG. 2b. Next to out coupling of the transported light and optionally converting as well, the sleeve-element can also be used for a beam direction functionality. E.g. the light can be emitted and/or reflected towards the place of interest (e.g. the plant leaves, the ripening fruits, etc.). This is suggested in FIG. 2c.

Another embodiment serves the purpose of localized heating source, using the segmented approach. Local heating of the plant or parts of the plant (an additional heat providing) can be much more efficient than increasing the temperature of the whole volume of e.g. a greenhouse. Various types of heating elements might be added to the strip (or could be the key function of the strip): radiator based on IR emitters, thermal heating elements based on heated filaments. Possibly micro-size air fans could be provided for transferring the heat to the plant.

As an additional function add-on, or as a separate key functionality, other functions with a segmented and tunable addressing could be claimed as well. These could for example be: elements for modifying locally the parameters related to artificial micro-climate generation, such as e.g.: humidity tuning: e.g. by water spray function, or by forced air flow (for drying or for increasing pollination efficiency); supply of Ethylene, CO₂, etc.

In embodiments, a light arrangement including non-galvanic energy out coupling may be used. For instance, for the case that additional lighting or non-lighting functionalities are to be added to the pre-fabricated (and preferably hermetic) light strip, one might ‘extract’ energy along the length of the lighting strip for powering such additional functionalities. Methods may be based on e.g.: optical powering: local out coupling combined with light conversion with PV element and use for powering additional function. This functionality could work onto a fully passive (wave guide only) light strip/light ribbon; inductive or capacitive powering: local out coupling with electrical conversion from inside to outside of the light strip, using either inductive or capacitive coupling. This requires electrical elements (conductive plates or strips, inductive elements such as coils, etc.) inside the light strip.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A horticulture lighting system comprising:
an elongated unit, the elongated unit having an elongated shape with a length, the elongated unit comprising comprises a plurality of light emitting regions adapted to emit horticulture light during operation of the horticulture lighting system, the elongated unit further comprising a LED strip with a plurality of LEDs configured at different positions along the length of the LED strip and arranged to provide LED light to the light emitting regions;
wherein the LED strip is bendable in a plurality of fixed configurations or rigid and configured for physically supporting a plant part of a plant, and/or
wherein the elongated unit further comprises a reinforcing element, wherein the reinforcing element is bendable in a plurality of fixed configurations or rigid, and wherein the reinforcing element is configured to support the LED strip and configured for physically supporting a plant part of a plant.

17. The lighting system of claim 16 further comprising a control system configured to control one or more of (i) intensities of the horticulture light of the plurality of light emitting regions, and (ii) spectral distributions of the horticulture light of the plurality of light emitting regions.

18. The lighting system of claim 16, wherein one or more lighting element regions are configured to receive LED light from one or more of the plurality of LEDs, convert at least part of said LED light with a wavelength converter into converted light, to thereby provide said horticulture light comprising at least part of said converted light.

19. The lighting system of claim 17, wherein one or more LEDs of the plurality of LEDs of the LED strip are radiationally coupled with an optical element for influencing at least one of a beam shape, a flux, an intensity and a spectral distribution of the horticulture light emitted by one or more of the plurality of light emitting regions.

20. The lighting system of claim 17, wherein one or more LEDs of the plurality of LEDs of the LED strip are intensity or color tunable and the control system (20) is adapted to individually control the intensity or spectral distribution of the LED light generated by each of the one or more LEDs.

21. The lighting system according to claim 16, further comprising one or more functional devices, wherein the one or more functional devices are configured for executing one or more of (i) measuring a temperature, (ii) measuring humidity, (iii) measuring light intensity, (iv) measuring spectral distribution of light, (v) measuring a gas, (vi) heating, (vii) providing water, (viii) providing a gas.

22. The lighting system according to claim 21 wherein at least one of the one or more functional devices is integrated with or attached to the elongated unit.

23. The lighting system according to claim 22 wherein an electrical power for the at least one of the one or more functional devices is extracted from the LED strip of the elongated unit.

24. The lighting system according to claim 16, comprising a plurality of LED strips moveably associated with the elongate unit for positioning the plurality of LEDs of the plurality of LED strips along the length of the elongated unit.

25. A method of treating a plant, the method comprising:
one or more of (i) physically guiding a plant part, selected from the group consisting of a plant stem, a plant branch, a fruit, and a flower, of a plant along an elongated unit of a horticulture lighting system according to any one of the preceding claims, and (ii) physically supporting a plant part selected from the group consisting of a plant stem, a plant branch, a fruit, and a flower, of said plant with the elongated unit of said horticulture lighting system; and
irradiating with horticulture light at least part of the plant using one or more LEDs of a LED strip comprised by the elongated unit of said horticulture lighting system.

26. The method of claim 25, comprising changing a location of said irradiating, along a length of the elongated unit, based on a growth phase of the plant part.
